(19) United States
(12) Patent Application Publication
(10) Pub. No.: US 2025/0068440 A1
(43) Pub. Date: Feb. 27, 2025

(54) VISUALIZATION SOFTWARE THAT ENABLES CREATING CUSTOM INTERFACES IN OPERATOR-MACHNE INTERFACE APPLICATIONS

(71) Applicant: Aveva Software, LLC, Lake Forest, CA (US)

(72) Inventors: Abhijit Manushree, Laguna Niguel, CA (US); Derrick Jones, Irvine, CA (US); Douglas Kane, Vashon, WA (US)

(73) Assignee: Aveva Software, LLC, Lake Forest, CA (US)

(21) Appl. No.: 18/806,108

(22) Filed: Aug. 15, 2024

Related U.S. Application Data
(60) Provisional application No. 63/534,062, filed on Aug. 22, 2023.

(51) Int. Cl. G06F 9/451

(52) U.S. Cl. CPC G06F 9/451

(57) ABSTRACT

Visualization software that enables creating custom interfaces in operator-machine interface applications is described. A system enables a user to define a script that includes custom logic and to identify corresponding data. The system configures an operator-machine interface application to execute the user-defined script at runtime, and deploys the user-defined script to a cloud platform. The operator-machine interface application subscribes to an attribute value associated with the user-defined script. The user-defined script executes a part of the custom logic, thereby retrieving the identified data via an application programming interface, transforming the retrieved data to a format used for display; and writing the formatted data to the attribute value. The operator-machine interface application displays content based on the subscribed attribute value.

### CROSS REFERENCE TO RELATED APPLICATION

This application claims priority under 35 U.S.C. § 119 or the Paris Convention from U.S. Provisional Patent Application 63/534,062, filed Aug. 22, 2023, the entire contents of which is incorporated herein by reference as if set forth in full herein.

### BACKGROUND

A data visualization platform is typically a combination of hardware and/or software that collects a large amount of data from an enterprise's industrial assets, creates easy-to-understand visual representations of the data, and executes visualization software that enables the enterprise's industrial operators to quickly understand the data and gain important insights into otherwise difficult-to-identify relationships, correlations, patterns, trends, variations, outliers, and unusual groupings within the data. A data visualization platform can execute applications for operator-machine interfaces (OMI), which may be referred to operator interfaces or human-machine interfaces, which use visual formats such as tables, charts, graphs, plots, maps, figures, matrices, and gauges which are static, dynamic, or interactive, which are accompanied by supporting texts such as labels and titles, and which may be combined in a dashboard. However, current visualization software does not enable a user to build and design a custom interface within an existing operator-machine interface application.

### BRIEF DESCRIPTION OF THE DRAWINGS

FIG. 1 illustrates an example of an on-premises use case for visualization software that enables creating custom interfaces in operator-machine interface applications, according to an embodiment.

FIG. 2 illustrates a high-level overview of a workflow which uses scripts for visualization software that enables creating custom interfaces in operator-machine interface applications, according to an embodiment.

FIG. 3 illustrates concurrent execution of instances of the same script with different parameters for visualization software that enables creating custom interfaces in operator-machine interface applications, according to an embodiment.

FIG. 4 illustrates examples of using a session script in the context of navigation, layouts, and content for visualization software that enables creating custom interfaces in operator-machine interface applications, according to an embodiment.

FIG. 5 illustrates a basic end to end workflow use case for visualization software that enables creating custom interfaces in operator-machine interface applications, according to an embodiment.

FIG. 6 illustrates operator-machine interfaces subscribing to attribute values of user-defined scripts for visualization software that enables creating custom interfaces in operator-machine interface applications, according to an embodiment.

FIG. 7 illustrates a high-level cloud user-defined object environment for visualization software that enables creating custom interfaces in operator-machine interface applications, according to an embodiment.

FIG. 8 depicts an example system for visualization software that enables creating custom interfaces in operator-machine interface applications, according to embodiment.

FIG. 9 depicts an extended reality engine for visualization software that enables creating custom interfaces in operator-machine interface applications, according to embodiment.

FIG. 10 depicts the exemplary computer-based systems, platforms, devices, and components for visualization software that enables creating custom interfaces in operator-machine interface applications, according to an embodiment.

FIG. 11 depicts a flowchart that illustrates an example computer-implemented method for visualization software that enables creating custom interfaces in operator-machine interface applications, according to an embodiment.

FIG. 12 depicts a block diagram illustrating an example hardware device in which the subject matter may be implemented.

### DETAILED DESCRIPTION

Visualization software that enables creating custom interfaces in operator-machine interface applications is described, according to an embodiment. A system enables a user to define a script that includes custom logic and to identify corresponding data. The system configures an operator-machine interface application to execute the user-defined script at runtime, and deploys the user-defined script to a cloud platform. The operator-machine interface application subscribes to an attribute value associated with the user-defined script. The user-defined script executes a part of the custom logic, thereby retrieving the identified data via an application programming interface, transforming the retrieved data to a format used for display; and writing the formatted data to the attribute value. The operator-machine interface application displays content based on the subscribed attribute value.

For example, an on-premises application server's integrated development environment enables April Devlin, an application developer, to create and define a script named Compare-to-Optimized-Pumps that includes custom logic which enables the comparison of data for feedwater pumps in an industrial facility to the data for optimized feedwater pumps in a nearby industrial facility. The integrated development environment configures an operator-machine interface application named Feedwater-Pumps to execute Devlin's script Compare-to-Optimized-Pumps at runtime, and deploys the script Compare-to-Optimized-Pumps to the cloud. The Feedwater-Pumps application subscribes to the attribute values for the script Compare-to-Optimized-Pumps. Devlin's script Compare-to-Optimized-Pumps executes the custom pump comparison logic, which includes retrieving the optimized pump's data via application programming interfaces, transforming the retrieved pump data to a display format, and writing the formatted pump data to the script's attribute values. The operator-machine interface application Feedwater-Pumps displays a comparison of the data for the feedwater pumps in an industrial facility to the data for the optimized feedwater pump in a nearby industrial facility, which enable an operator to partially optimize the operation of at least one feedwater pump.

In various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. Operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

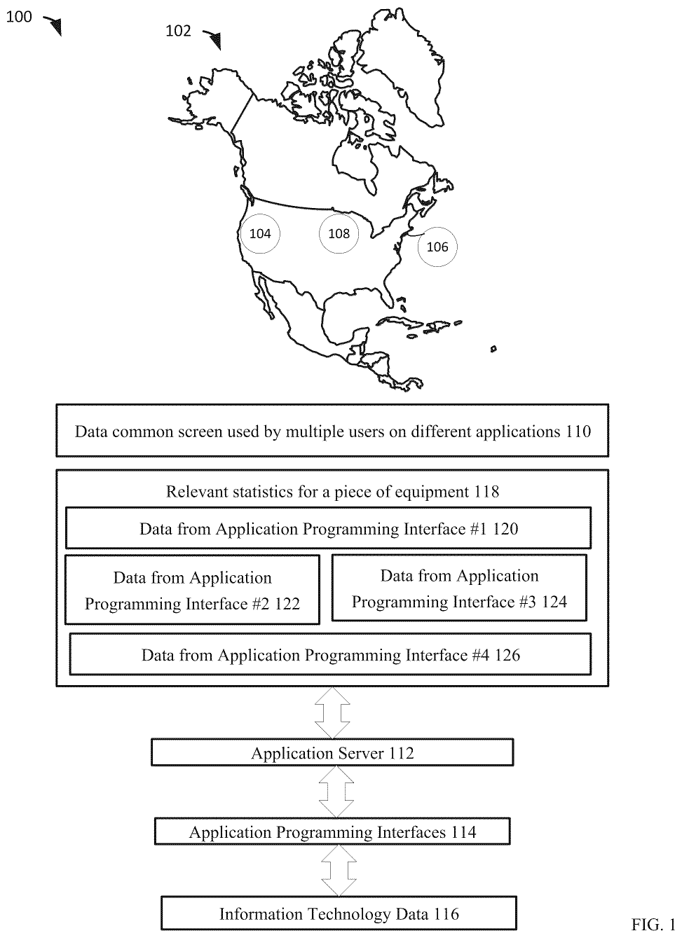

FIG. 1 illustrates an example of an on-premises use case for visualization software that enables creating custom interfaces in operator-machine interface applications, according to an embodiment. The use case operator-machine interface application relies on information technology data stored in the cloud to provide an overview of equipment relative to its location throughout the world. Since each site of an industrial enterprise may have significant amounts of industrial assets such as equipment, and this equipment changes, there is no static asset hierarchy. A user clicks on an icon on a map 102 that represents multiple industrial facilities 104, 106, and 108, or their sub-components, and the operator-machine interface application responds with a common data screen 110 for the selected entity, which is a screen that is not specific to any user.

Each industrial facility typically has large numbers of pieces of equipment and each piece of equipment may be associated with significant amounts of data. A user can select a usage pattern for equipment and its data from an operator-machine interface that depicts the selected facility. An application server 112 which is executing an operator-machine interface application responds to the user's selection(s) by calling many different web application programming interfaces 114 to load the requested information technology data 116 from information technology systems, and transforms the data to a display format, which enables displaying the formatted data to the corresponding user. For example, one usage pattern is based on the common display screen 110 for a site overview, which is used by multiple users on different applications.

An operator-machine interface application can change the information technology data access steps to enable a user to specifically define what data is accessed and returned based on that user's needs and/or a particular useful context. For example, another usage pattern is based on one user selecting to review relevant statistics for a piece of equipment 118, which requires the addition of custom logic to the operator-machine interface application to access the custom data from the application programming interfaces numbers #1 120, #2 122, #3 124, and #4 126. The following description details system implemented steps stored on one or more non-transitory computer readable media and executed by one or more processors in one or more computers that extend the functionality of standard or “off the shelf” operator-machine interface applications through scripting, which enables users to create scripts that customize an operator-machine interface application's output based on user-defined business logic. The scripts enable users to instruct an operator-machine interface's application to cross cloud boundaries to retrieve data from different divergent data sources simultaneously, such as Google® database and Amazon® database, and thereby provide customized visualization of data from different data sources.

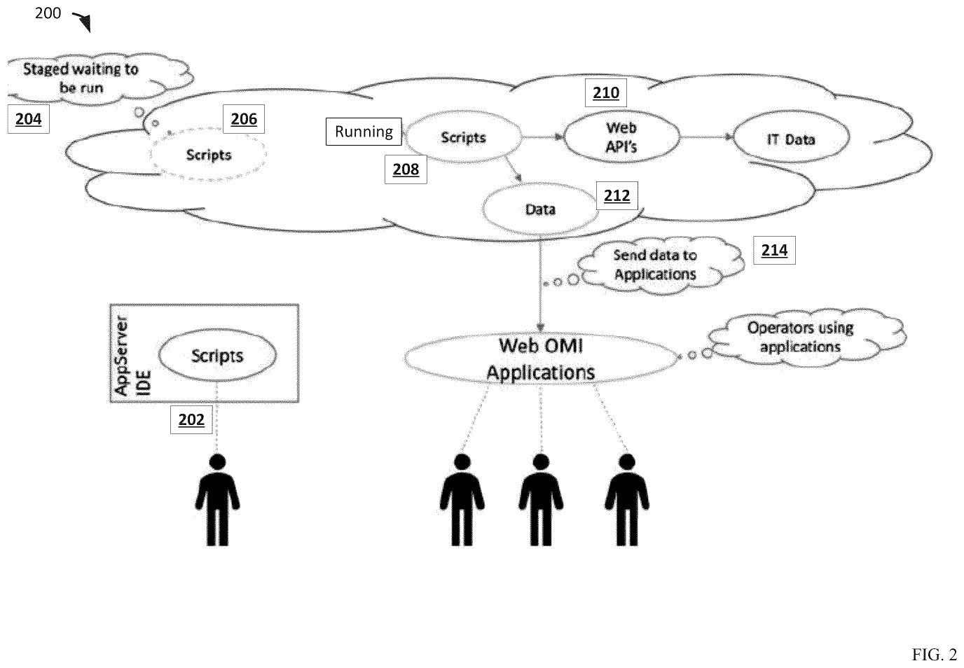

FIG. 2 illustrates a high-level overview of a workflow which uses scripts for visualization software that enables creating custom interfaces in operator-machine interface applications, according to an embodiment. In step 202, an application developer uses an on-premises integrated development environment (IDE) to build scripts that include custom business logic which the developer wishes to implement, and configures the scripts to access information technology (IT) data, such as data in an enterprise's backend warehouse in the cloud via web application programing interfaces. In step 204, the developer deploys the scripts to a cloud platform where the scripts wait to be run. Typically, human operators interact with applications via operator-machine interfaces. In step 206, the operator-machine interfaces' applications are deployed for being hosted on the cloud.

In step 208, the operator-machine interfaces' applications execute the scripts, which can include session scripts and/or periodic scripts, which take parameters based on a developer's intent and execute business logic that includes context specific action accessing information technology data, such as webservices in the cloud or a managed SQL database, and/or operational technology (OT) data, such as data on site. In step 210, the executing scripts call web application programing interfaces to access information technology data. In step 212, the executing scripts transform the accessed information technology data into a format that may be rendered in web content for an operator-machine interface or a format that may be written to a data storage block. In step 214, the cloud platform sends the transformed/formatted data to the operator-machine interface applications, which receive the transformed/formatted data and/or display content based on the transformed/formatted data, which are the results of executing the scripts.

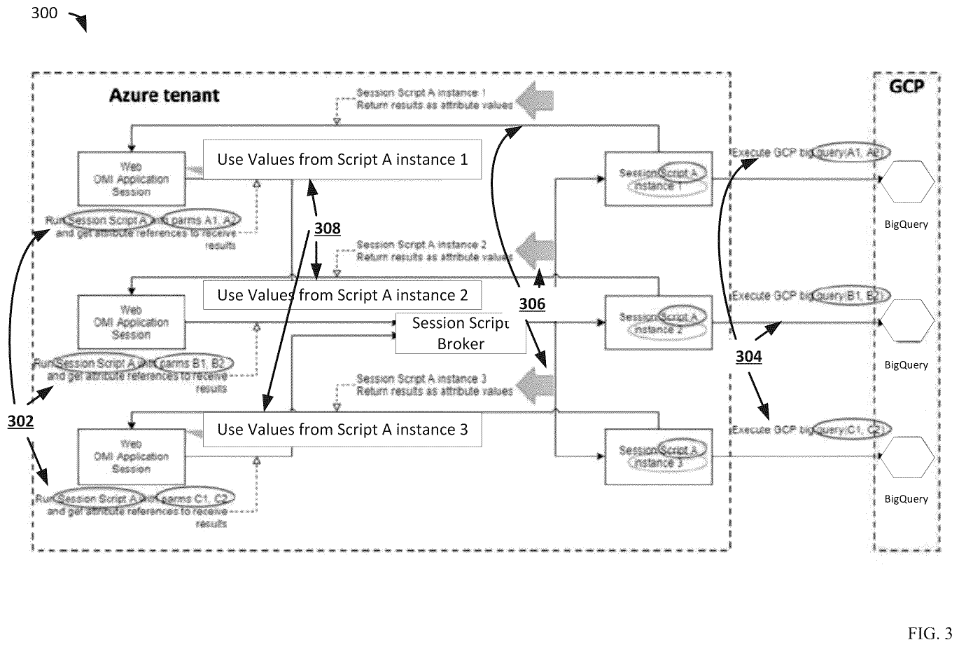

FIG. 3 illustrates concurrent execution of instances of the same script with different parameters for visualization software that enables creating custom interfaces in operator-machine interface applications, according to an embodiment. In step 302, after an operator-machine interface application deploys session scripts in a cloud platform, multiple backend web sessions for operator-machine interface applications execute the session scripts, with each session script passing corresponding parameters. In step 304, multiple backend web sessions for operator-machine interface applications can concurrently execute different instances of the same session script that pass different parameters as unique instances with different parameters, such that each instance can use query calls that retrieve data from a 3^{rd} party tenant in the Google cloud platform. For example, FIG. 3 depicts that a first web session for an operator-machine interface application executes a first instance of a session script A with parameters A1 and A2, a second web session for an operator-machine interface application executes a second instance of the same session script A, but with different parameters B1 and B2, and a third web session for an operator-machine interface application executes a third instance of the same session script A, but with different parameters C1 and C2. In step 306, the executing session scripts can determine the resulting data, transform the data, and return the transformed data as values to the web operator-machine interface application via attribute values for an instance of the session script. In step 308, the instances of the operator-machine interface applications receive the transformed data via the attribute values for the instance of the session script, and display the attribute values to the requesting user.

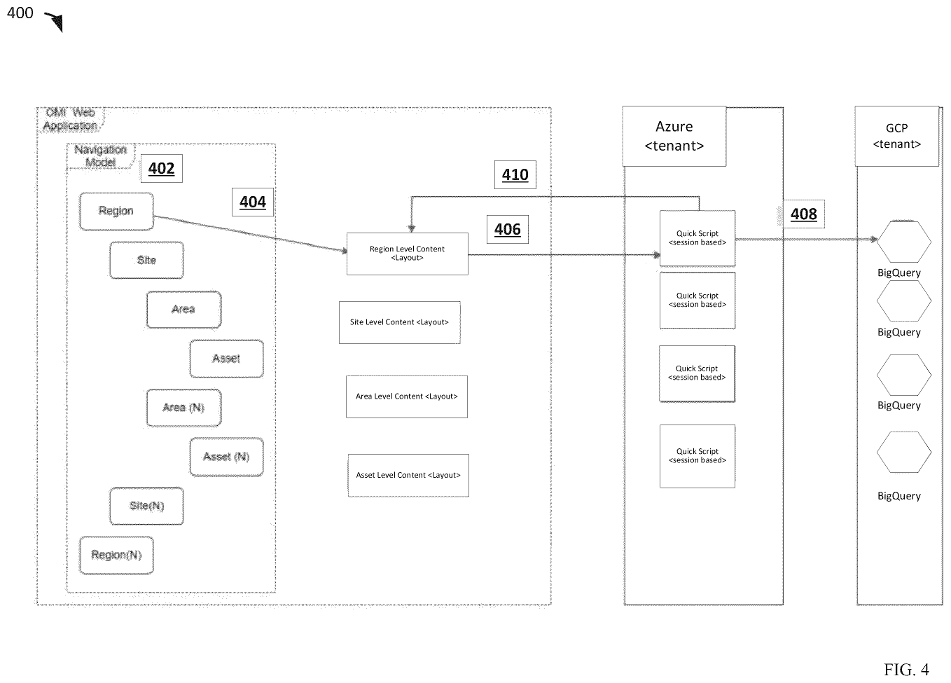

FIG. 4 illustrates examples of using a session script in the context of navigation, layouts, and content for visualization software that enables creating custom interfaces in operator-machine interface applications, according to an embodiment. In step 402, an operator-machine interface application enables a user to click on a node, such as a “region” node, in a navigation tree model. In step 404, the model responds by executing a layout loading for the user's selected node. In step 406, after the node's layout content loads, the operator-machine interface application executes a session script to get the data needed to populate content for the user's selected node.

In step 408, a session script written by a developer can execute a web application programming interface call to get information technology data, and then write the results to attributes used by layout content. The session script returns attributes obtained from the information technology data, and can change at least a portion of the standard content displayed by the layout for the selected node with the attribute values returned by the session script. In step 410, the node layout content receives data updates for attribute values from the session script and the content is populated.

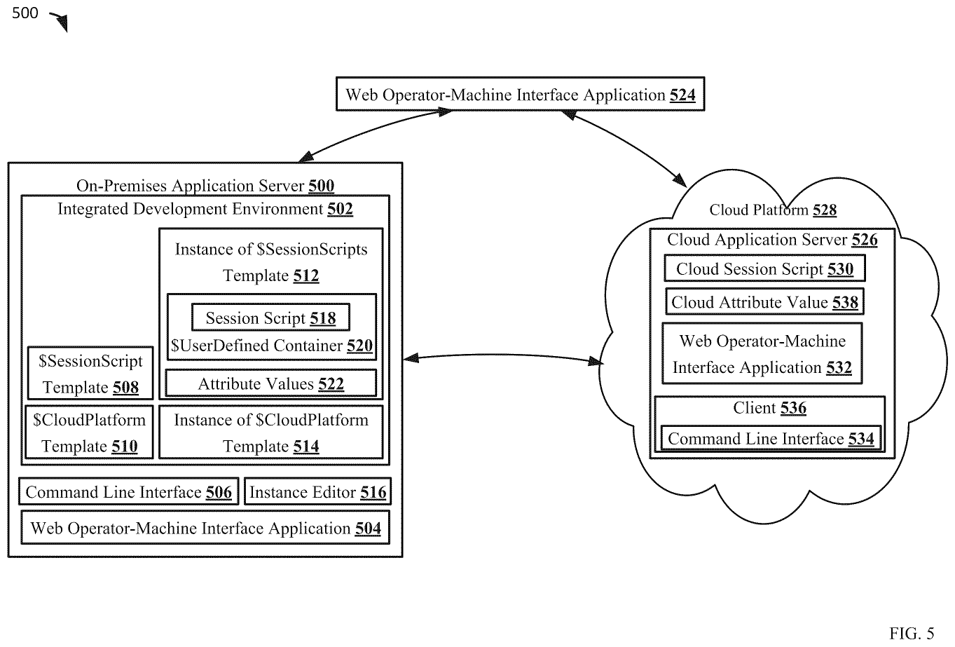

FIG. 5 illustrates a basic end to end workflow use case for visualization software that enables creating custom interfaces in operator-machine interface applications, according to an embodiment. An on-premises application server 500 provides an integrated development environment 502 that uses a web operator-machine interface 504 or a command line interface 506 to import a session script template 508 and a cloud platform template 510, creates an instance of the session script template 512 and an instance of the cloud platform template 514, assigns the instance of the session script template 512 to be hosted by the instance of the cloud platform template 514, opens an instance editor 516 with core capabilities, and then creates or edits scripts 518 in the instance of the session script template 512, which may be stored in the user-defined container 520 in the on-premises application server 500, which also stores the attribute values 522 for the scripts 518. The on-premises application server 500 configures an operator-machine interface application 524 (and possibly also a widget. a layout script, and/or a content script) to execute a session script 518 at runtime when the application 524 is deployed. The on-premises application server 500 uses the web operator-machine interface 504 or the command line interface 506 to connect with a cloud application server 526 on the cloud platform 528 and deploy the session scripts 518 as cloud session scripts 530 to the cloud application server 526 on the cloud platform 528.

The cloud application server 526 on the cloud platform 528 uses a web operator-machine interface 532 or a command line interface 534 for a client 536 to initiate the cloud session script 530, and then the initiator 532 or 536 subscribes to a cloud attribute value 538 for the cloud session script 530, and waits for results. The cloud session script 530 can execute as a managed Azure identify, read its attributes, execute user-defined custom logic, access a 3^{rd} party cloud tenant, execute to completion, and/or write the results as the cloud attribute values 538. The attribute value changes for the cloud session script 530 are transformed and then published to the web operator-machine interface application 532, the client 536, a web operator-machine interface's 3^{rd} party application, and/or a web widget used by the 3^{rd} party cloud tenant.

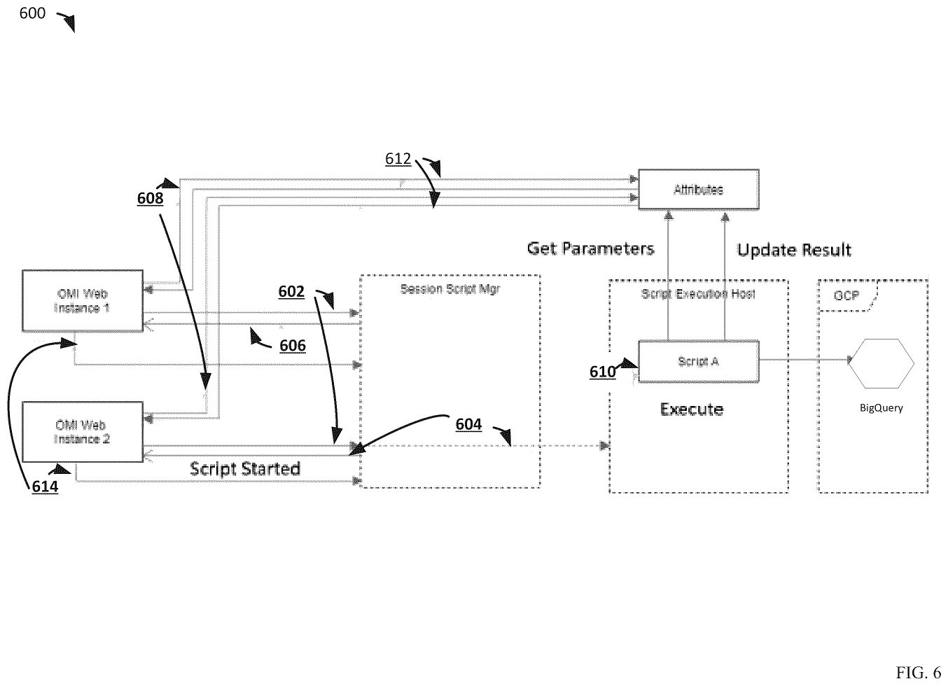

FIG. 6 illustrates operator-machine interfaces subscribing to attribute values of user-defined scripts for visualization software that enables creating custom interfaces in operator-machine interface applications, according to an embodiment. This subscribing is within the context of “light weight” cloud-based user-defined object instance support. At step 602, an operator-machine interface's web application instance 1 and web application instance 2 start a user-defined Script A at the same time. At step 604, the web application instance 2 sends a request to launch the script and receives a response from the session script manager which indicates that a script execution host has started executing Script A, and also identifies the script's attributes.

At step 606, the web application instance 1 sends a request to start executing Script A, and receives a response from the session script manager which indicates that the script execution host has started executing Script A and which also identifies the script's attributes. At step 608, both the operator-machine interface's web application instance 1 and web application instance 2 subscribe to the attributes for Script A and wait for the results. At step 610, the script execution host executes Script A and updates its attributes, which at step 612 enables both of the operator-machine interface's web application instance 1 and web application instance 2 to get updates from the script's attributes to which they subscribed. At step 614, both the operator-machine interface's web application instance 1 and the web application instance 2 periodically keep the communication channel active by making a “keep alive” call until they are finished waiting for the script results.

The supporting parameters include a script execution interval and a keep alive timeout. The script execution interval defines the frequency at which a script will run, and is passed in when the script is started. The keep alive timeout is passed in when a script is started. If the timeout expires without a “keep alive” call from the client, the script is not re-executed.

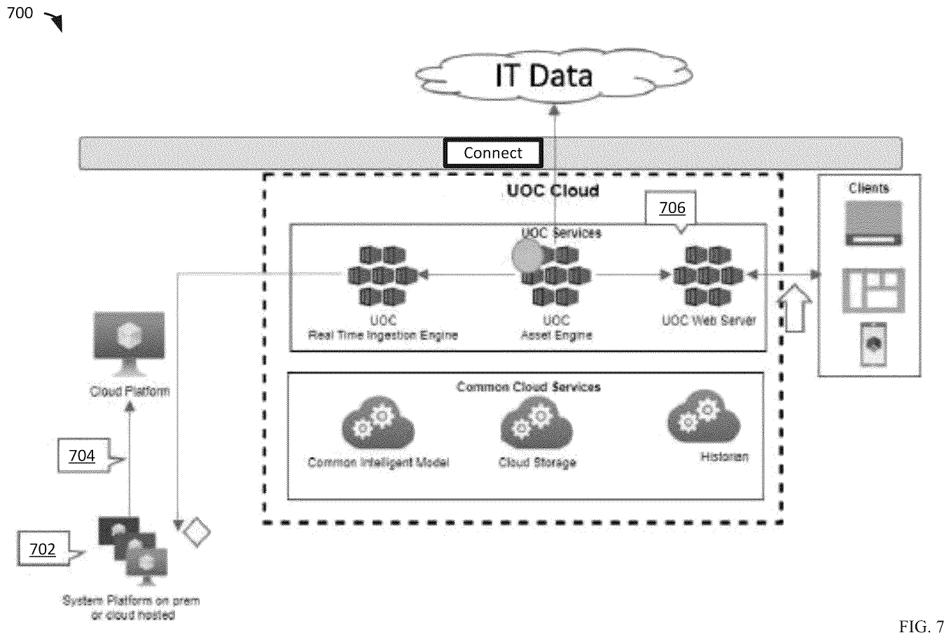

FIG. 7 illustrates a high-level cloud environment of a user-defined object for visualization software that enables creating custom interfaces in operator-machine interface applications, according to an embodiment. At step 702, a system platform that is on-premises or hosted in a cloud can enable a user to build user-defined objects with attributes and scripts in an application server's integrated development environment. At step 704, an application server's integrated development environment can commission cloud native applications, and both deploy and/or un-deploy cloud user-defined objects in a cloud platform.

At step 706, the cloud-hosted user-defined object can operate using data from information technology and operational technology systems, with the cloud-based user-defined object's scripts accessing the information technology data and/or operational technology data, which are then made accessible to clients as attribute values. The cloud-hosted user-defined object's attributes may be accessed from the operator-machine interface applications hosted in the cloud and the operator-machine interface's native applications. A cloud-hosted user-defined object can also access on-premises application server data.

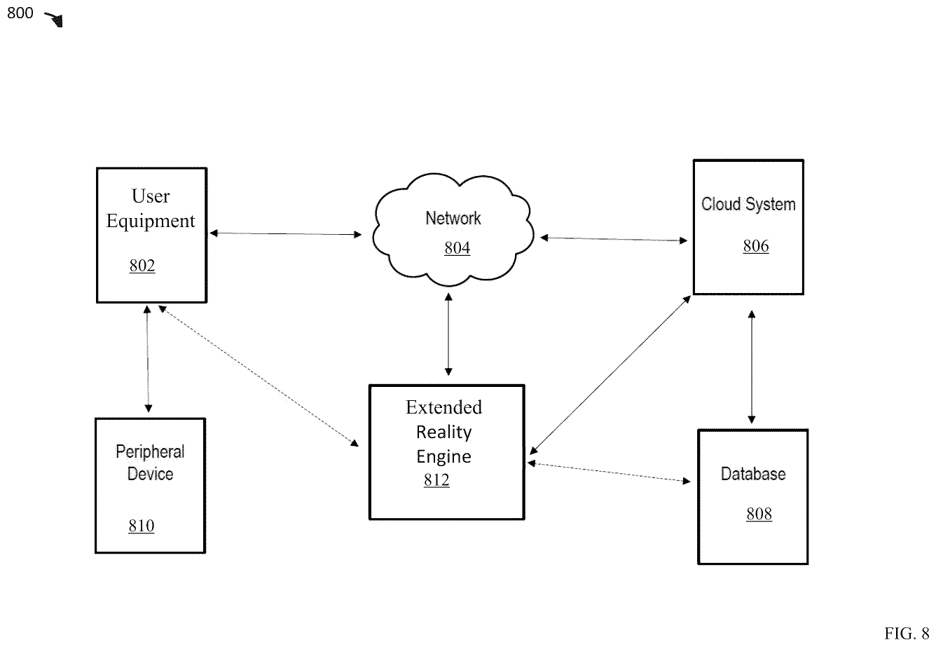

FIG. 8 depicts an example system 800 for visualization software that enables creating custom interfaces in operator-machine interface applications, according to an embodiment. The system 800 includes user equipment 802, such as a client device, a network 804, a cloud system 806, a database 808, a peripheral device 810, and an extended reality engine 812. It should be understood that while the system 800 is depicted as including such components, such depiction should not be construed as limiting, as one of ordinary skill in the art would readily understand that varying numbers of user equipment, peripheral devices, cloud systems, databases and networks may be utilized.

The user equipment 802 may be any type of device, such as, but not limited to, a mobile phone, tablet, laptop, sensor, Internet of Things (IoT) device, autonomous machine, and any other device equipped with a cellular or wireless or wired transceiver. The user equipment 802 may be a device associated with an individual (or set of individuals). The user equipment 802 may correspond to a device having a corresponding peripheral device 810, as discussed herein.

The peripheral device 810 may be connected to the user equipment 802, and may be any type of peripheral device, such as, but not limited to, a wearable device, such as a smart watch, a printer, a speaker, a sensor, and/or anything similar. The peripheral device 810 may be any type of device that is connectable to the user equipment 802 via any type of known or to be known pairing mechanism, including, but not limited to, Bluetooth™, Bluetooth Low Energy (BLE), NFC, and the like. The network 804 may be any type of network, such as, but not limited to, a wireless network, cellular network, the Internet, and the like (as discussed above). The network 804 facilitates connectivity of the components of the system 800.

The cloud system 806 may be any type of cloud operating platform and/or network-based system upon which applications, operations, and/or other forms of network resources may be located. For example, the cloud system 806 may be a service provider and/or network provider from where services and/or applications may be accessed, sourced or executed from. For example, the cloud system 806 can represent the cloud-based architecture, which has associated network resources hosted on the internet or private network, such as the network 804, which enables (via the extended reality engine 812) creation, hosting and/or interaction, as discussed herein.

The cloud system 806 may include a server(s) and/or a database of information which is accessible over the network 804. The database 808 of the cloud system 806 may store a dataset of data and metadata associated with local and/or network information related to a user(s) of the user equipment 802, the peripheral device 810, and the services and applications provided by the cloud system 806 and/or the extended reality engine 812. For example, the cloud system 806 can provide a private/proprietary industrial software platform, such as AVEVA™, whereby the extended reality engine 812, discussed infra, corresponds to the novel functionality that the cloud system 806 enables, hosts and provides to the network 804 and other devices/platforms operating thereon.

The database 808 may correspond to a data storage for a platform such as a network hosted platform, such as the cloud system 806, as discussed supra, or multiple platforms. The database 808 may receive storage instructions/requests from, for example, the extended reality engine 812 (and associated microservices), which may be in any type of known or to be known format, such as, for example, standard query language (SQL).

The database 808 may correspond to a distributed ledger of a distributed network. The distributed network may include multiple distributed network nodes, where each distributed network node includes and/or corresponds to a computing device associated with at least one entity, such as the entity associated with the cloud system 806, discussed supra. Each distributed network node may include at least one distributed network data store that can store distributed network-based data objects for the at least one entity. For example, the database 808 may correspond to a blockchain, where the distributed network-based data objects can include, but are not limited to, account information, medical information, entity identifying information, wallet information, device information, network information, credentials, security information, permissions, identifiers, smart contracts, transaction history, and the like, or any other type of known or to be known data/metadata related to an entity's and/or user's information, structure, business and/or legal demographics, inter alia.

The extended reality engine 812 can include components for the disclosed functionality. The extended reality engine 812 may be a special purpose machine or processor and may be hosted by a device on the network 804, within the cloud system 806 and/or on the user equipment 802 (and/or the peripheral device 810). The extended reality engine 812 may be hosted by a server and/or set of servers associated with the cloud system 806. As discussed in more detail below, the extended reality engine 812 may implement and/or control multiple services and/or microservices, where each of the multiple services/microservices can execute multiple workflows associated with performing the disclosed functionality.

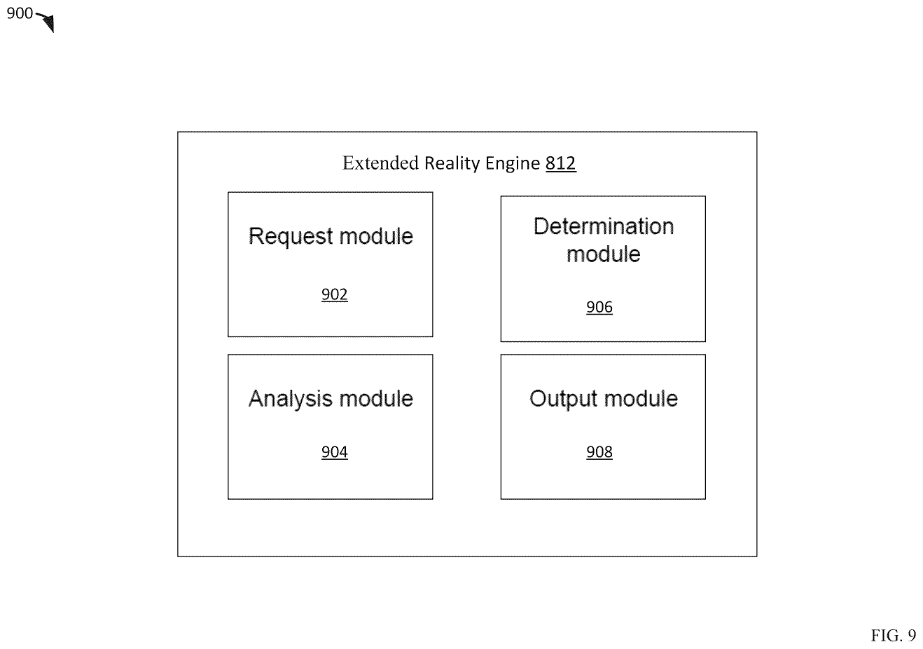

FIG. 9 depicts an extended reality engine for visualization software that enables creating custom interfaces in operator-machine interface applications, according to embodiment. The extended reality engine 812 includes a request module 902, an analysis module 904, a determination module 906, and an output module 908. It should be understood that the engine(s) and modules discussed herein are non-exhaustive, as additional or fewer engines and/or modules (or sub-modules) may be applicable to the embodiments of the systems and methods discussed. For example, engineering data may be, but is not limited to, 1D, 2D, 3D, 4D and/or 5D data. For example, the 1D (1 dimensional) data can correspond to and/or include 1D simulations that assist engineering users in understanding the interaction of different components within a system. Accordingly, such simulations, whether 1D or 5D, for example, can provide design information for a broad range of mechanical, electronical, pneumatic and/or hydraulic industries, such as construction, oil refinery, shipbuilding, aerospace, automotive, and the like.

Accordingly, the engineering data can enable the renderings of the interaction of components with their surroundings, such as 2D/3D data, in addition to an entire design of a system and the systems components' interactions, such as 1D data. As such, such data can include, but is not limited to, the parameters of the physical models of assets and/or endpoint spaces, such as design, structure and make-up information. For example, operational data can include, but is not limited to, the physical properties and the mechanisms for which assets operate within a space/endpoint. For example, such data can include, but is not limited to, PI/ADH, AIM-A/Insight, and the like.

For example, maintenance data can include, but is not limited to, data integration and transformation software data which allows users to develop and execute workflows. Such data can correspond to parameters related to, but not limited to, efficiency operations, anomalies, errors, fixes, patches, and the like, or some combination thereof. The maintenance data can enable intelligent asset management, which can involve, but is not limited to, SAP data and/or applications, Maximo data and/or applications, and/or any other type of application or software suite that enables maintenance operations for a digital/virtual environment, or some combination thereof.

By way of an example, such 3D data can include any type of known or to be known 3D data that may be generated, such as via scanning and creating 3D representations, searched and identified, requested, or otherwise identified, and can correspond to, but is not limited to, CAD (computer aided design), point clouds, such as Laser Point Clouds, LiDAR, photogrammetry, meshes, parametric models, depth-maps, RGB-D, multi-view images, voxels or constructive solid geometry, and the like.

Accordingly, such functionalities may be provided by local and/or web-hosted modules that can execute so as to realize the operational environment via the system. The system environment, embodied as a product, may be provided via Cloud functionality, such as via AVEVA Connect®, which can allow enterprise users to scan an industrial plant and/or its associated assets so as to enable the plant and/or its assets to be reviewed and/or monitored. such scanning/review can enable the replication of such plant/assets as I/Os within AR/VR/MR/XR environments, where the I/Os consume all standard features of the plant/assets.

The system environment, embodied as a project, may be provided via Cloud functionality, such as via AVEVA Connect®, which can allow enterprise users to view a pre-defined and published plant(s) and/or asset. Accordingly, the scanning/review/consumption of the plant and/or its assets may be configured as with the product discussed above, and the extended reality engine 812 can enable the engagement with the space. The system may require the extended reality engine 812 to import the assets and plant information so as to enable the scripting of the plant/assets behaviors, such as in addition to the scripting available via a template(s), and to deploy the final release to the Cloud/storage, which can have a high impact on SIs.

As discussed above, the extended reality engine 812 may function as an application provided by the cloud system 806. The extended reality engine 812 may function as an application installed on a server(s), network location and/or other type of network resource associated with the cloud system 806. The extended reality engine 812 may function as an application installed and/or executing on the user equipment 802. Such an application may be a web-based application accessed by user equipment 802 and/or devices associated with peripheral device 810 over network 804 from cloud system 806. The extended reality engine 812 may be configured and/or installed as an augmenting script, program or application, such as a plug-in or extension, to another application or program provided by cloud system 806 and/or executing on user equipment 802 and/or peripheral device 810.

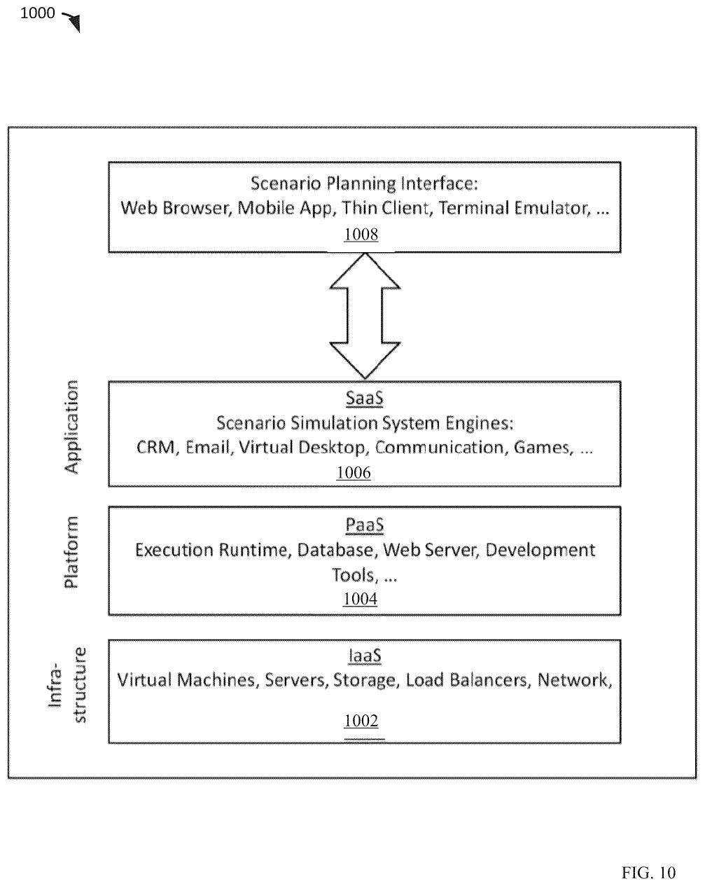

FIG. 10 illustrates the exemplary computer-based systems, platforms, devices, and components, for visualization software that enables creating custom interfaces in operator-machine interface applications, according to an embodiment. The exemplary computer-based entities may be specifically configured to operate in a cloud computing/architecture 806 such as, but not limited to: an infrastructure as a service (IaaS) 1002, a platform as a service (PaaS) 1004, and/or software as a service (Saas) 1006, using a web browser, mobile app, thin client, terminal emulator or other endpoint 1008. FIG. 10 illustrates schematics of non-limiting implementations of the cloud computing/architecture(s) in which the exemplary computer-based systems for administrative customizations and control of network-hosted application programming interfaces of the present disclosure may be specifically configured to operate.

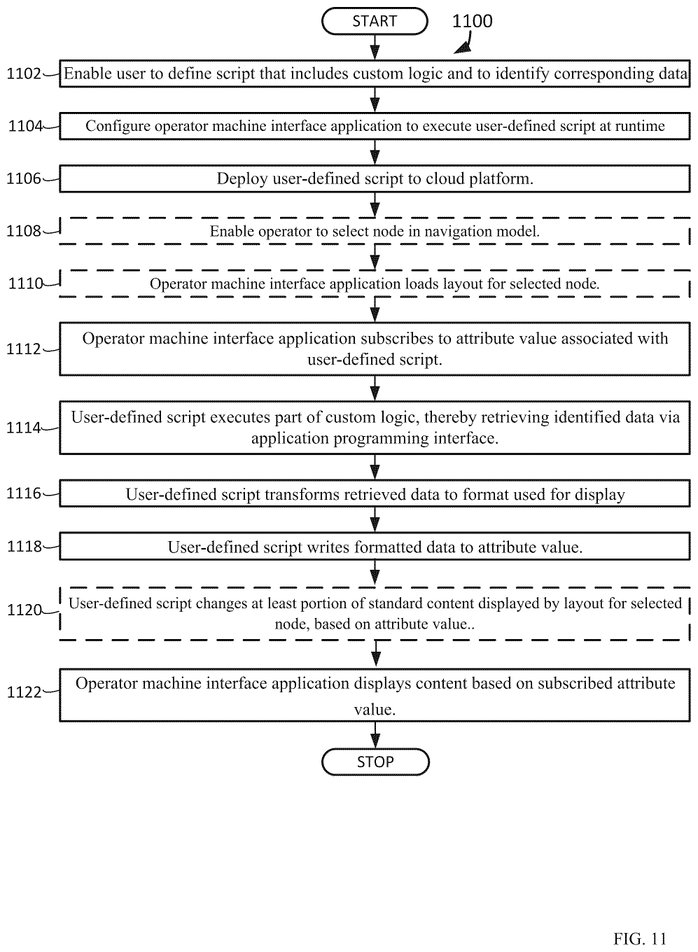

FIG. 11 depicts a flowchart that illustrates an example computer-implemented method for visualization software that enables creating custom interfaces in operator-machine interface applications, under an embodiment. Flowchart 1100 depicts method acts illustrated as flowchart blocks for certain actions involved in and/or between the system elements 802-812 of FIG. 8.

A user is enabled to define a script that includes custom logic and to identify corresponding data, block 1102. The system helps a developer develop a script for custom interfaces in operator-machine interface applications. For example, and without limitation, this can include an on-premises application server's integrated development environment enabling April Devine, an application developer, to create and define a script that she named Compare-to-Optimized-Pumps, which includes custom logic that enables the comparison of data for feedwater pumps in an industrial facility to the data for optimized feedwater pumps in a nearby industrial facility.

A user can be a person who operates a computer. A script can be an automated series of instructions carried out in a specific order. Custom logic can be the personally created rules or algorithms that handle the exchange of information between a database and a user interface. Data can be information that may be interpreted and used by computers.

Enabling a user to define a script that includes custom logic and to identify corresponding data may include importing a session script template and a cloud platform template, creating an instance of the session script template and an instance of the cloud platform template, assigning the instance of the session script template to the instance of the cloud platform template, and opening an instance editor, which enables creating the script in the instance of the session script template. For example, the on-premises application server's integrated development environment imports a $SessionScript template and a $CloudPlatform template, creates an instance of the $SessionScript template and an instance of the $CloudPlatform template, assigns the instance of the $SessionScript template to the instance of the $CloudPlatform template, and opens an instance editor, which enables April Device to create the script Compare-to-Optimized-Pumps in the instance of the $SessionScript template.

A session script template can be a preset format for a file that lists commands or functions that a system executes in the sequence listed, which is used so that the format does not have to be_recreated each time it is used. A cloud platform template can be a preset format for a combination of hardware, software, and operating system that provides remote computing services to customers, used so that the format does not have to be recreated each time it is used. An instance can be a single occurrence or a copy of an object or class. An instance editor can be a tool that allows users to define and modify occurrences or copies of models, classes, or schedules.

Enabling a user to define a script that includes custom logic and to identify corresponding data may include enabling the user to build a user-defined object corresponding to the script. For example, the on-premises application server's integrated development environment enables Devlin to create an object for storing the data for the optimized pumps in the nearby industrial facility, one of which will have its data positioned side-by-side with the data for Oppenheimer's selected feedwater pump in an industrial facility. A user-defined object can be a data structure which may be a part of other data structures and/or which may include additional data structures.

After a user is enabled to define a script, an operator-machine interface application is configured to execute the user-defined script at runtime, block 1104. The system enables an operator-machine interface application to run a user-defined script. By way of example and without limitation, this can include the on-premises application server's integrated development environment configuring the operator-machine interface application Feedwater-Pumps to execute Devlin's script Compare-to-Optimized-Pumps at runtime.

An operator-machine interface application can be software that enables a human to interact with an automated machine or system. A user-defined script can be an automated series of instructions which are carried out in a specific order, and which are created by a human. Runtime can be the chronological duration when a program is executing.

Following configuration of an operator-machine interface application to execute a user-defined script, the user-defined script is deployed to a cloud platform, block 1106. The system sends the user's script to be executed on the cloud. In embodiments, this can include the on-premises application server's integrated development environment deploying Devlin's script Compare-to-Optimized-Pumps script to the cloud. A cloud platform can be a combination of hardware, software, and operating system that provides remote computing services to customers.

Deploying a user-defined script to a cloud platform may include deploying a user-defined object and the corresponding script to the cloud platform. For example, the on-premises application server's integrated development environment deploys Devlin's Compare-to-Optimized-Pumps script, and Devlin's object for storing the data for the optimized pumps in the nearby industrial facility, one of which will have its data positioned side-by-side with the data for Oppenheimer's selected feedwater pump in an industrial facility, to the cloud.

Having deployed a user-defined script to a cloud platform, an operator is optionally enabled to select a node in a navigation model, block 1108. The system can enable operators to navigate between an operator-machine interface's display screens. For example, and without limitation, this can include the operator-machine interface application Feedwater-Pumps enabling Ian Oppenheimer, an industrial operator, to select a feedwater pump icon from a screen which displays icons which represent the industrial equipment in an industrial facility.

An operator can be a person who is responsible for maintaining the functioning of an industrial facility. A node can be a selectable point in a symbolic representation of information using visualization techniques. A navigation model can be a plan that enables users to open and move through display screens.

After an operator optionally selects a node in a navigation model, an operator-machine interface application optionally loads a layout for the selected node, block 1110. The system can load the data layout for the operator's selected node. By way of example and without limitation, this can include the operator-machine interface application Feedwater-Pumps loading a data layout for the feedwater pump represented by the icon which Oppenheimer selected. A layout can be the way in which text or pictures are set out on a page. A selected node can be a chosen point in a symbolic representation of information using visualization techniques.

Following deployment of a user-defined script to a cloud, an operator-machine interface application subscribes to an attribute value associated with the user-defined script, block 1112. The system subscribes to the user-defined script's data. In embodiments, this can include the operator-machine interface application Feedwater-Pumps subscribing to the attribute values for Devlin's script Compare-to-Optimized-Pumps. An attribute value can be a piece of data that describes a specific member or object.

Subscribing to an attribute value associated with a user-defined script may be in response to an identification of the attribute value associated with the user defined script starting execution. For example, the operator-machine interface application Feedwater-Pumps subscribes to the attribute value for Devlin's script Compare-to-Optimized-Pumps in response to an identification of the attribute values sent by the script execution host with the confirmation that Devlin's script Compare-to-Optimized-Pumps began execution, started, or initiated, as requested by the operator-machine interface application Feedwater-Pumps. An identification can be the action or process of recognizing something.

After subscribing to data for a user-defined script, the user-defined script executes a part of the custom logic, thereby retrieving the identified data via an application programming interface, block 1114. The system retrieves the data for the user-defined script. For example, and without limitation, this can include Devlin's script Compare-to-Optimized-Pumps executing the custom logic which includes retrieving the data for the optimized pumps via application programming interfaces. A part can be a piece or segment of something such as an object, activity, or period of time, which combined with other pieces makes up the whole. An application programming interface can be a set of rules and protocols that allow different software applications to interact with each other.

A user-defined script executing custom logic may include identifying a total count of parameter sets to be passed by the user-defined script, thereby resulting in creating the total count of instances of the user-defined script and the total count of sessions for the operator-machine interface application, and concurrently executing, by the total count of sessions, the total count of instances of the user-defined script that pass the total count of the parameter sets. For example, Devlin's script Compare-to-Optimized-Pumps executes and then identifies three sets of parameters for three optimized feedwater pumps in the nearby industrial facility, which results in the initial instance of Devlin's script Compare-to-Optimized-Pumps spawning two additional instances of Devlin's script, and initiating three web backend application sessions, which concurrently execute the three instances of Devlin's script Compare-to-Optimized-Pumps with the three sets of parameters. A total count can be the sum of all the elements in a set. A parameter set can be a collection of variables and their associated values which may be used in various contexts.

Retrieving, by the user-defined script, the identified data may include retrieving, by the total count of instances of the user-defined script, subsets of the identified data corresponding to the total count of parameter sets. For example, the three instances of Devlin's script Compare-to-Optimized-Pumps use the three sets of parameters to concurrently retrieve three sets of data for optimized pumps from the nearby industrial facility. A subset can be a part of a larger group of related things.

Following the retrieval of data, a user-defined script transforms the retrieved data to a format used for display, block 1116. The system formats the user-defined script's data to be displayed. By way of example and without limitation, this can include Devlin's script Compare-to-Optimized-Pumps transforming the three sets of retrieved pump data to a display format. Retrieved data can be information which may be interpreted and used by computers and which has been found or extracted. A format can be the way in which something is arranged or set out.

Having formatted data for display, a user-defined script writes the formatted data to an attribute value, block 1118. The system makes the user-defined script's data available. In embodiments, this can include Devlin's script Compare-to-Optimized-Pumps writing the formatted pump data to the attribute values for the optimized pumps. Formatted data can be the way in which information that may be interpreted and used by computers is arranged or set out.

After writing data to an attribute value, a user-defined script optionally changes at least a portion of standard content displayed by a layout for a selected node, based on the attribute value, block 1120. The system can modify the selected display's layout based on the data for the user-defined script. For example, and without limitation, this can include Devlin's script Compare-to-Optimized-Pumps changing the content displayed by the layout for the feedwater pump which Oppenheimer selected, by inserting the data for an optimized pump at the nearby industrial facility next to the data for Oppenheimer's selected feedwater pump. A portion can be a part of a whole. Standard content can be the information which is typically made available by a website or other electronic medium.

Following the writing of a user-defined script's data to an attribute value, an operator-machine interface application displays content based on the subscribed attribute value, block 1122. The system displays the data for the user-defined script. Displaying content based on a subscribed attribute value may be further based on a layout for a selected node. By way of example and without limitation, this can include the operator-machine interface application Feedwater-Pumps displaying data for an optimized pump at the nearby industrial facility in a modified layout next to the data for Oppenheimer's selected feedwater pump, which enables Oppenheimer to partially optimize his selected feedwater pump. Content can be the information which is available by a website or other electronic medium. A subscribed attribute value can be a piece of data which describes a specific member or object, and which has been arranged in advance to be received somewhat regularly, typically via a publication,

Displaying content based on a subscribed attribute value may include getting updates from the subscribed attribute value and periodically making, by the operator-machine interface application, a request to continue receiving communications as long as updates are needed from the subscribed attribute value. For example, the operator-machine interface application Feedwater-Pumps periodically requests to continue receiving updates of the data for the optimized pumps until Oppenheimer selects to navigate to a different display screen. A request can be an instruction to a computer to provide information or perform another function. A communication can be the imparting or exchanging of information or news. An update can be the act of making something more modern or recent.

The subscribed attribute value may be based on at least one of information technology data, operational technology data, or on-premise application server data. For example, the subscribed attribute value for the optimized pumps is based on operational technology data. Information technology data can be the study or use of systems (especially computers and telecommunications) for storing, retrieving, and sending facts. Operational technology data can be information which may be interpreted and used by computers and which hardware and software detects or causes a change, through the direct monitoring and/or control of industrial equipment. On-premise application server data can be information which may be interpreted and used by a computer that executes software hosted locally on an organization's own hardware infrastructure and data center.

Although FIG. 11 depicts the blocks 1102-1122 occurring in a specific order, the blocks 1102-1122 can occur in another order. In other implementations, each of the blocks 1102-1122 can also be executed in combination with other blocks and/or some blocks may be divided into a different set of blocks.

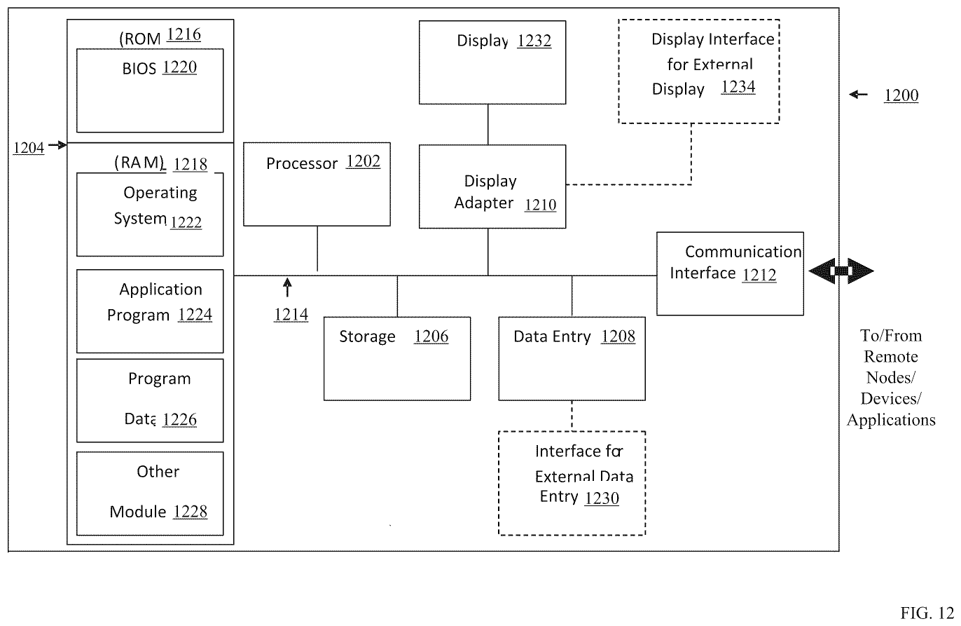

An exemplary hardware device in which the subject matter may be implemented shall be described. Those of ordinary skill in the art will appreciate that the elements illustrated in FIG. 12 can vary depending on the system implementation. With reference to FIG. 12, an exemplary system for implementing the subject matter disclosed herein includes a hardware device 1200, including a processing unit 1202, a memory 1204, a storage 1206, a data entry module 1208, a display adapter 1210, a communication interface 1212, and a bus 1214 that couples elements 1204-1212 to the processing unit 1202.

The bus 1214 can comprise any type of bus architecture. Examples include a memory bus, a peripheral bus, a local bus, etc. The processing unit 1202 is an instruction execution machine, apparatus, or device and can comprise a microprocessor, a digital signal processor, a graphics processing unit, an application specific integrated circuit (ASIC), a field programmable gate array (FPGA), etc. The processing unit 1202 may be configured to execute program instructions stored in the memory 1204 and/or the storage 1206 and/or received via the data entry module 1208.

The memory 1204 can include a read only memory (ROM) 1216 and a random-access memory (RAM) 1218. The memory 1204 may be configured to store program instructions and data during operation of the hardware device 1200. In various embodiments, the memory 1204 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 1204 can also include nonvolatile memory technologies such as nonvolatile flash RAM (NVRAM) or ROM. It is contemplated that the memory 1204 can include a combination of technologies such as the foregoing, as well as other technologies not specifically mentioned. When the subject matter is implemented in a computer system, a basic input/output system (BIOS) 1220, containing the basic routines that help to transfer information between elements within the computer system, such as during start-up, is stored in the ROM 1216.

The storage 1206 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 1200.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 1206, the ROM 1216 or the RAM 1218, including an operating system 1222, one or more applications programs 1226, program data 1226, and other program modules 1228. A user can enter commands and information into the hardware device 1200 through data entry module 1208. The data entry module 1208 can include mechanisms such as a keyboard, a touch screen, a pointing device, etc.

Other external input devices (not shown) are connected to the hardware device 1200 via an external data entry interface 1210. By way of example and not limitation, external input devices can include a microphone, joystick, game pad, satellite dish, scanner, or the like. The external input devices can include video or audio input devices such as a video camera, a still camera, etc. The data entry module 1208 may be configured to receive input from one or more users of the hardware device 1200 and to deliver such input to the processing unit 1202 and/or the memory 1204 via the bus 1214.

A display 1212 is also connected to the bus 1214 via the display adapter 1210. The display 1212 may be configured to display output of the hardware device 1200 to one or more users. A given device such as a touch screen, for example, can function as both the data entry module 1208 and the display 1212. External display devices can also be connected to the bus 1214 via the external display interface 1234. Other peripheral output devices, not shown, such as speakers and printers, may be connected to the hardware device 1200.

The hardware device 1200 can operate in a networked environment using logical connections to one or more remote nodes (not shown) via the communication interface 1212. The remote node may be another computer, a server, a router, a peer device or other common network node, and typically includes many or all of the elements described above relative to the hardware device 1200. The communication interface 1212 can interface with a wireless network and/or a wired network. Examples of wireless networks include, for example, a BLUETOOTH network, a wireless personal area network, a wireless 802.21 local area network (LAN), and/or wireless telephony network, such as a cellular, PCS, or GSM network.

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. A communication interface 1212 can include logic configured to support direct memory access (DMA) transfers between the memory 1204 and other devices.

In a networked environment, program modules depicted relative to the hardware device 1200, or portions thereof, may be stored in a remote storage device, such as, for example, on a server. It will be appreciated that other hardware and/or software to establish a communications link between the hardware device 1200 and other devices may be used.

It should be understood that the arrangement of the hardware device 1200 illustrated in FIG. 12 is but one potential implementation and that other arrangements are feasible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 1200.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 12.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms: Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example. As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system.

The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data may be processed by other computers on the network, e.g., a cloud of computing resources.

The embodiments of the system can also be defined as a machine that transforms data from one state to another state. The data can represent an article, which can be represented as an electronic signal and electronically manipulate data. The transformed data can, in some cases, be visually depicted on a display, representing the physical object that results from the transformation of data. The transformed data may be saved to storage generally, or in particular formats that enable the construction or depiction of a physical and tangible object. The manipulation can be performed by a processor.

In such an example, the processor thus transforms the data from one thing to another. Still further, some embodiments include methods that can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output. It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

What is claimed is:

1. A system for visualization software that enables creating custom interfaces in operator-machine interface applications, the system comprising:
one or more processors; and
a non-transitory computer readable medium storing a plurality of instructions, which when executed, cause the one or more processors to:
enable a user to define a script that includes custom logic and to identify corresponding data;
configure an operator-machine interface application to execute the user-defined script at runtime;
deploy the user-defined script to a cloud platform;
subscribe, by the operator-machine interface application, to an attribute value associated with the user-defined script;
execute, by the user-defined script, a part of the custom logic, thereby retrieving the identified data via an application programming interface;
transform, by the user-defined script, the retrieved data to a format used for display;
write, by the user-defined script, the formatted data to the attribute value; and
display, by the operator-machine interface application, content based on the subscribed attribute value.

2. The system of claim 1, wherein enabling the user to define the script that includes custom logic and to identify corresponding data comprises importing a session script template and a cloud platform template, creating an instance of the session script template and an instance of the cloud platform template, assigning the instance of the session script template to the instance of the cloud platform template, and opening an instance editor, which enables creating the script in the instance of the session script template.

3. The system of claim 1, wherein the plurality of instructions further causes the processor to:
load, by the operator-machine interface application, a layout for a selected node, in response to enabling an operator to select the node in a navigation model; and
change, by the user-defined script, at least a portion of standard content displayed by the layout for the selected node, based on the attribute value, wherein displaying content based on the subscribed attribute value is further based on the layout for the selected node.

4. The system of claim 1, wherein subscribing to the attribute value associated with the user-defined script is in response to an identification of the attribute value associated with the user defined script starting execution, and displaying content based on the subscribed attribute value comprises getting updates from the subscribed attribute value and periodically making, by the operator-machine interface application, a request to continue receiving communications as long as updates are needed from the subscribed attribute value.

5. The system of claim 1, wherein the user-defined script executing the custom logic comprises identifying a total count of parameter sets to be passed by the user-defined script, thereby resulting in creating the total count of instances of the user-defined script and the total count of sessions for the operator-machine interface application, and concurrently executing, by the total count of sessions, the total count of instances of the user-defined script that pass the total count of the parameter sets.

6. The system of claim 5, wherein retrieving the identified data via the application programming interface comprises retrieving, by the total count of instances of the user-defined script, subsets of the identified data corresponding to the total count of parameter sets.

7. The system of claim 1, wherein enabling the user to define the script that includes custom logic and to identify corresponding data comprises enabling the user to build a user-defined object corresponding to the script, wherein deploying the user-defined script to the cloud platform comprises deploying the user-defined object with the user-defined script to the cloud platform, and wherein the content based on the subscribed attribute value comprises at least one of information technology data, operational technology data, or on-premise application server data.

8. A computer-implemented method for visualization software that enables creating custom interfaces in operator-machine interface applications, the computer-implemented method comprising:
enabling a user to define a script that includes custom logic and to identify corresponding data;
configuring an operator-machine interface application to execute the user-defined script at runtime;
deploying the user-defined script to a cloud platform;
subscribing, by the operator-machine interface application, to an attribute value associated with the user-defined script;
executing, by the user-defined script, a part of the custom logic, thereby retrieving the identified data via an application programming interface;
transforming, by the user-defined script, the retrieved data to a format used for display;
writing, by the user-defined script, the formatted data to the attribute value; and
displaying, by the operator-machine interface application, content based on the subscribed attribute value.

9. The computer-implemented method of claim 8, wherein enabling the user to define the script that includes custom logic and to identify corresponding data comprises importing a session script template and a cloud platform template, creating an instance of the session script template and an instance of the cloud platform template, assigning the instance of the session script template to the instance of the cloud platform template, and opening an instance editor, which enables creating the script in the instance of the session script template.

10. The computer-implemented method of claim 8, wherein the computer-implemented method further comprises:
loading, by the operator-machine interface application, a layout for a selected node, in response to enabling an operator to select the node in a navigation model; and
changing, by the user-defined script, at least a portion of standard content displayed by the layout for the selected node, based on the attribute value, wherein displaying content based on the subscribed attribute value is further based on the layout for the selected node.

11. The computer-implemented method of claim 8, wherein subscribing to the attribute value associated with the user-defined script is in response to an identification of the attribute value associated with the user defined script starting execution, and displaying content based on the subscribed attribute value comprises getting updates from the subscribed attribute value and periodically making, by the operator-machine interface application, a request to continue receiving communications as long as updates are needed from the subscribed attribute value.

12. The computer-implemented method of claim 8, wherein the user-defined script executing the custom logic comprises identifying a total count of parameter sets to be passed by the user-defined script, thereby resulting in creating the total count of instances of the user-defined script and the total count of sessions for the operator-machine interface application, and concurrently executing, by the total count of sessions, the total count of instances of the user-defined script that pass the total count of the parameter sets.

13. The computer-implemented method of claim 12, wherein retrieving the identified data via the application programming interface comprises retrieving, by the total count of instances of the user-defined script, subsets of the identified data corresponding to the total count of parameter sets.

14. The computer-implemented method of claim 8, wherein enabling the user to define the script that includes custom logic and to identify corresponding data comprises enabling the user to build a user-defined object corresponding to the script, wherein deploying the user-defined script to the cloud platform comprises deploying the user-defined object with the user-defined script to the cloud platform, and wherein the content based on the subscribed attribute value comprises at least one of information technology data, operational technology data, or on-premise application server data.

15. A computer program product, comprising a non-transitory computer-readable medium having a computer-readable program code embodied therein to be executed by one or more processors, the program code including instructions to:
enable a user to define a script that includes custom logic and to identify corresponding data;
configure an operator-machine interface application to execute the user-defined script at runtime;
deploy the user-defined script to a cloud platform;
subscribe, by the operator-machine interface application, to an attribute value associated with the user-defined script;
execute, by the user-defined script, a part of the custom logic, thereby retrieving the identified data via an application programming interface;
transform, by the user-defined script, the retrieved data to a format used for display;
write, by the user-defined script, the formatted data to the attribute value; and
display, by the operator-machine interface application, content based on the subscribed attribute value.

16. The computer program product of claim 15, wherein enabling the user to define the script that includes custom logic and to identify corresponding data comprises importing a session script template and a cloud platform template, creating an instance of the session script template and an instance of the cloud platform template, assigning the instance of the session script template to the instance of the cloud platform template, and opening an instance editor, which enables creating the script in the instance of the session script template.

17. The computer program product of claim 15, wherein the program code includes further instructions to:
load, by the operator-machine interface application, a layout for a selected node, in response to enabling an operator to select the node in a navigation model; and
change, by the user-defined script, at least a portion of standard content displayed by the layout for the selected node, based on the attribute value, wherein displaying content based on the subscribed attribute value is further based on the layout for the selected node.

18. The computer program product of claim 15, wherein subscribing to the attribute value associated with the user-defined script is in response to an identification of the attribute value associated with the user defined script starting execution, and displaying content based on the subscribed attribute value comprises getting updates from the subscribed attribute value and periodically making, by the operator-machine interface application, a request to continue receiving communications as long as updates are needed from the subscribed attribute value.

19. The computer program product of claim 15, wherein the user-defined script executing the custom logic comprises identifying a total count of parameter sets to be passed by the user-defined script, thereby resulting in creating the total count of instances of the user-defined script and the total count of sessions for the operator-machine interface application, and concurrently executing, by the total count of sessions, the total count of instances of the user-defined script that pass the total count of the parameter sets, and wherein retrieving the identified data via the application programming interface comprises retrieving, by the total count of instances of the user-defined script, subsets of the identified data corresponding to the total count of parameter sets.

20. The computer program product of claim 15, wherein enabling the user to define the script that includes custom logic and to identify corresponding data comprises enabling the user to build a user-defined object corresponding to the script, wherein deploying the user-defined script to the cloud platform comprises deploying the user-defined object with the user-defined script to the cloud platform, and wherein the content based on the subscribed attribute value comprises at least one of information technology data, operational technology data, or on-premise application server data.
